(19) United States
(12) Patent Application Publication
(10) Pub. No.: US 2019/0374881 A1
(43) Pub. Date: Dec. 12, 2019

(54) PLEATED MULTILAYER FILTER FOR PULSED OPERATION

(71) Applicant: EAGLE FILTERS OY, Kotka (FI)

(72) Inventor: Juha Kariluoto, Kotka (FI)

(21) Appl. No.: 16/481,335

(22) PCT Filed: Dec. 12, 2017
(86) PCT No.: PCT/FI2017/050876

§ 371 Date: Jul. 26, 2019

(30) Foreign Application Priority Data
Jan. 31, 2017 (FI) 20175083

(51) Int. Cl. B01D 29/03; B01D 29/66

(52) U.S. Cl. CPC B01D 29/031; B01D 46/0024; B01D 29/66

(57) ABSTRACT

The invention relates to a pulse filter having two stage filters, each having filtering properties different from each other. The first stage filter, through which the fluid flow to be cleaned passes first, is arranged to filter coarser materials and the second stage filter is arranged to filter finer substance from the fluid flow. The first and second stage filter are formed as separate pleated structures, which are optionally a distance forming an air gap away from each other.

The present invention relates a pulse filter having two stage filters, each having filtering properties different from each other, wherein the first outer stage filter, through which the fluid flow to be cleaned passes first, is arranged to filter coarser materials and the second inner stage filter is arranged to filter finer substance from the fluid flow, the inner stage filter defining a clean air channel inside of it, the pulse filter being arranged to be cleaned by applying to it pulses of compressed air in the opposite direction in relation to the airflow to be filtered.

Pulse filters are self-cleaning filters, in which the substance collected into the filter is detached by pulses of compressed air in the opposite direction in relation to the airflow to be filtered. The filter material captures particle-like material from the airflow. In the course of use, particle-like substance collects onto the filter causing a decrease in airflow and a drop in pressure through the filter. Cleaning of the filters can be arranged, for example, such that the pressure loss is measured over each filter and when a given level of pressure loss is reached, the filter is automatically cleaned by applying to it pulses of compressed air, the pressure of which can be, for example, 5.5-6.9 bar of overpressure, their duration being, for example, 100-200 ms. The detached substance falls from the filter downwards and is collected, for example, into an impure air collection chamber.

These pulse filters are of different forms, for example, cylindrical, oval, rectangular, V-shaped, etc.

One application site for such pulse filters is energy production facilities, such as, for example, gas turbine engines and the like, in which large amounts of clean air are needed for a combustion process. Impurities, such as dust particles and salts in the intake air of a compressor, can cause damage, for example, through erosion, corrosion and the like to the various components of a compressor and, in general, an entire gas turbine engine, weakening its effectiveness. For this reason, intake air is typically filtered by filters.

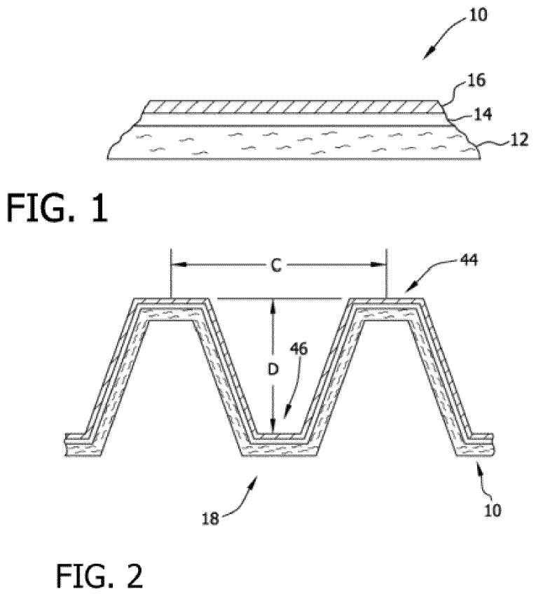

From prior art are known multi-layered filters, the filter layers of which are laminated together to form one stage filter. For example, US2012/0186452 A1 describes a multi-layered HEPA filter having a first layer of synthetic nonwoven fabric, to which is laminated a second layer, which is formed from a microporous membrane. To the second layer is further laminated a third layer, which contains a synthetic nonwoven fabric formed from at least two synthetic fibres with different melting points. The filter further includes end caps. FIGS. 1 and 2 show a schematic cross-sectional view of the filter material of a filter according to such known art.

The object of the present invention is to provide an improved pulse filter solution, which offers a more durable structure and easier cleanability.

In order to achieve this object, a pulse filter according to the invention is characterized in that the first and second stage filters are formed as separate pleated structures, which are optionally a distance forming an air gap away from each other.

Because the stage filters are separate and between them is optionally a small air gap, an easier cleanability is achieved and, further, a more durable structure. Because the filter material must be flexible in order to withstand pulses of compressed air, by using separate layers it is possible to use a thicker support material (150 g/m²) in connection with the inner layer than in structures formed as a single layer, in which the support material can be in the range of 20-30 g/m². Too thick a support structure in a single-layer structure decreases the utilizable surface area. By a filter according to the invention, there is achieved in tests over 5000 cleaning cycles without any weakening of the filtering capability.

In the following, the invention is described in more detail with reference to the accompanying drawings, in which:

FIGS. 1-2 show a cross-sectional view of a layer-structured filter material according to known art,

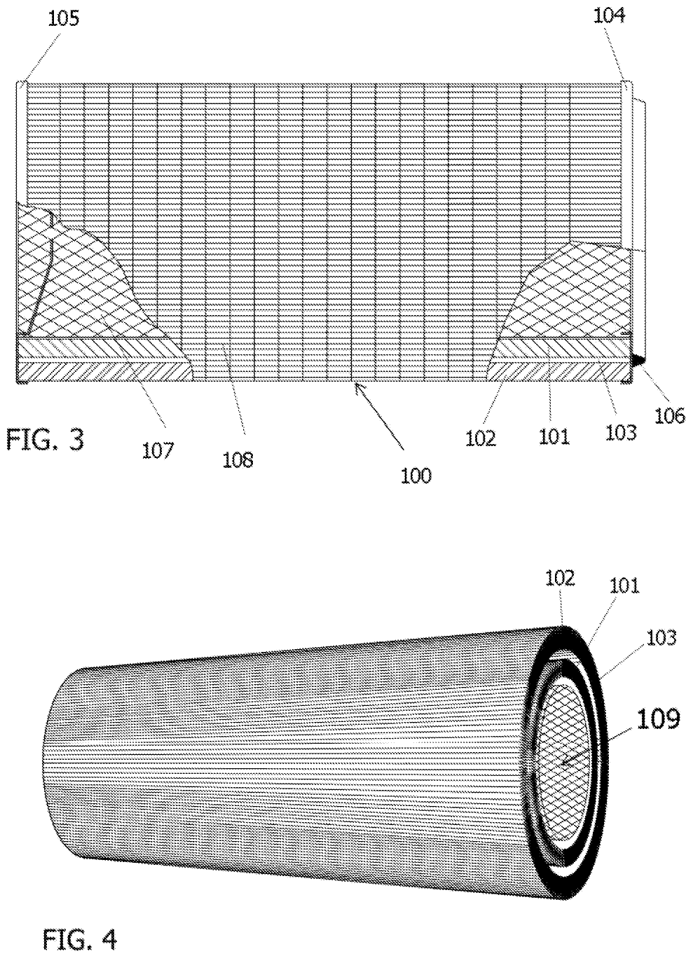

FIG. 3 shows a schematic, partially sectional view of an embodiment of a filter according to the invention,

FIG. 4 shows an isometric view of a filter material of the filter according to FIG. 3,

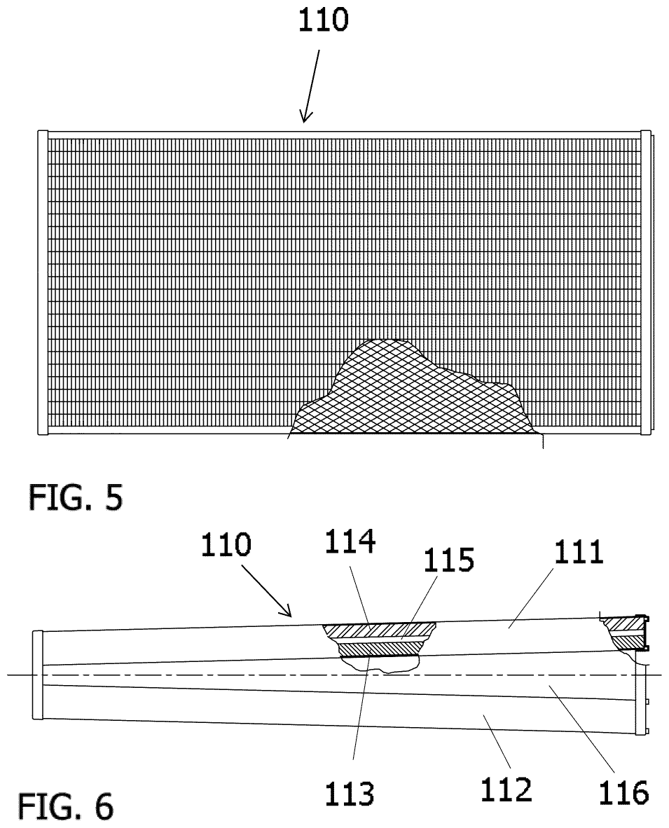

FIG. 5 shows a schematic, partially sectional view of another embodiment of a filter according to the invention,

FIG. 6 shows a partially sectional view, as seen from the side, of the filter according to FIG. 5, and

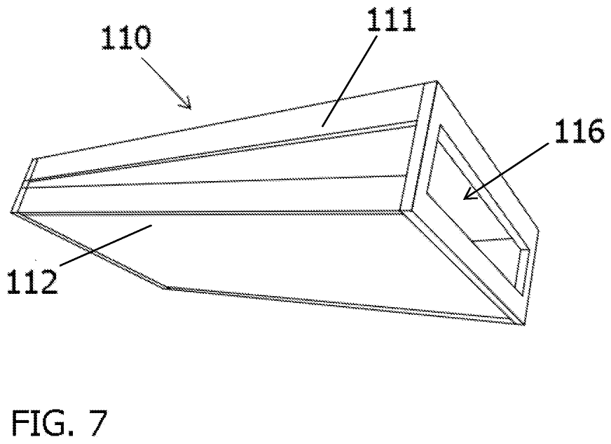

FIG. 7 shows an isometric view of the filter according to FIGS. 5-6.

FIGS. 1 and 2 show a sectional view of the filter material 10 of a multi-layered HEPA filter known from US2012/0186452 A1. The filter material 10 comprises a first layer 12, a second layer 14 laminated on top of the first layer 12, and a third layer 16 laminated on top of the second layer 14. FIG. 2 shows the pleats 18 formed in the filter material 10.

FIG. 3 shows a schematic, partially sectional view of an embodiment of a filter 100 according to the invention. The filter 100 is formed as cylindrical, comprising an inner stage filter 101 and an outer stage filter 102, each in a cylindrical form. The outer surface of the inner stage filter and the inner surface of the outer stage filter are a radial distance forming a gap 103 away from each other. The width of the gap is preferably in the range of 0-20 mm, i.e. the stages can be in contact with each other, but they are not attached to each other. Each of the longitudinal ends of the filter has cap parts 104 and 105. The cap part 104 is equipped with a seal 106. To the inner surface of the inner stage filter 101 is arranged a support frame 107 and to the outer surface of the outer stage filter 102 a protective screen or fabric 108. To the middle of the filter is formed a cylindrical clean air channel 109, which opens from one end into the application site or a feeder channel leading thereto the second end being closed.

FIGS. 5-7 show another embodiment of a filter according to the invention. In this embodiment, the filter 110 is formed as a V-shaped filter, which has an upper plate-like filter part 111 and a lower plate-like filter part 112, the filter parts 111,112 forming the arms of the V. Each of the filter parts has an outer stage filter 114 and an inner stage filter 113, between which can optionally be formed a gap 115, the width of which is preferably in the range of 0-20 mm. Between the inner surfaces of the inner stages 113 is formed a clean air channel 116 widening from one end towards the opposite end. In the exemplary case, the channel 116 is closed from its narrower end, opening from its wider end into the application site or a feeder channel leading thereto.

In both of the embodiments presented above, the air to be cleaned flows first through the outer stage filter 102, 114 and optionally via the gap 103, 115 through the inner stage filter 101, 113 into the clean air channel 109, 116, from which it further flows through the open end into the application site or a feeder channel leading thereto. The differential pressure through the filter material is measured and, when a predefined drop in pressure is detected, to the filter are applied pulses of compressed air in the opposite direction in relation to the airflow to be filtered in order to detach the therein-attached substance from the filter material.

Due to the separate structure of the stage filters, in the inner stage filters 101, 113 a thicker support fabric can be used, which mechanically protects the actual filter material and also does not limit the surface area of the outer stage filter. Further, the filter material is cleaned more effectively due to the gap, because each filtering layer is better able to move under the influence of the pressure pulses. Due to its separate structure, the depth of the pleats of the stage filters is shallower than in the case of a multi-layered material, contributing to assist with cleaning.

1. A pulse filter having two stage filters, each having filtering properties different from each other, wherein the first outer stage filter, through which the fluid flow passes first, is arranged to filter coarser materials and the second inner stage filter is arranged to filter finer substance from the fluid flow, the inner stage filter defining a clean air channel inside of it, the pulse filter being arranged to be cleaned by applying to it pulses of compressed air in the opposite direction in relation to the airflow to be cleaned, characterized in that the first and second stage filter are formed as separate pleated structures, which are optionally a distance forming an air gap away from each other.

2. A pulse filter according to claim 1, characterized in that the first and second stage filter are arranged in a cylindrical form, wherein the gap between them is formed as annular and the clean air channel inside the inner stage is formed as cylindrical.

3. A pulse filter according to claim 1, characterized in that the first and second stage filter are arranged, as viewed in a longitudinal section, in a V-shape, wherein the inner stage filter forms the inner sides of the V, between which is formed the cleaned fluid channel, the distance between the opposite sides of which increases from one end of the filter towards its opposite end.

4. A pulse filter according to claim 3, characterized in that the fluid channel is closed from its narrower end and opens from its wider end into the application site of the cleaned fluid flow or into a feeder channel leading into the application site.

5. A pulse filter according to claim 1, characterized in that the optional air gap between the first and second layers is in the range of 0-20 mm.
